(19) United States
(12) Patent Application Publication
(10) Pub. No.: US 2011/0205430 A1
(43) Pub. Date: Aug. 25, 2011

(54) CAPTION MOVEMENT PROCESSING APPARATUS AND METHOD

(75) Inventors: Akihiro MINAGAWA, Kawasaki (JP); Yutaka KATSUYAMA, Kawasaki (JP); Yoshinobu HOTTA, Kawasaki (JP)

(73) Assignee: Fujitsu Limited, Kawasaki (JP)

(21) Appl. No.: 13/101,214

(22) Filed: May 5, 2011

Related U.S. Application Data
(63) Continuation of application No. PCT/JP2008/070608, filed on Nov. 12, 2008.

(51) Int. Cl. H04N 7/00

(52) U.S. Cl. 348/468; 348/E07.033

(57) ABSTRACT

An apparatus includes: a unit to identify first pixels belonging to a first portion regarded as a character string that is inserted with an overlap on a background in an expanded image generated by expanding a specific frame image included in video image data; a unit to determine whether any one of the first pixels is out of a display area that is a part of the expanded image and to calculate a movement amount for moving the first portion so as to make all of the first pixels accommodated in the display area when it is determined that any one of the first pixels is out of the display area; and a unit to identify a movement destination pixel for each of the first pixels or the like, according to the movement amount, and to replace a color of the movement destination pixel with a predetermined color.

### CROSS-REFERENCE TO RELATED APPLICATIONS

This application is a continuing application, filed under 35 U.S.C. section 111(a), of International Application PCT/JP2008/070608, filed Nov. 12, 2008.

### FIELD

This technology relates to an image processing technique.

### BACKGROUND

For example, a “1-segment receiving service for a cellular phone or mobile terminal” (also called “One Seg”) is being provided for mobile terminals such as cellular phones.

By the way, there are mobile terminals, which are capable of handling “One Seg” but have a small display screen, and such mobile terminals have a function for expanding the display of part of a video image. For example, when expanding the display based on the center of the video image, some areas in a peripheral area of the video image protrude out of the display frame, and a caption that is inserted in the peripheral area of the video image is not displayed. Incidentally, the caption is often inserted in the peripheral area of the video image. In addition, this problem is not limited to mobile terminals that are capable of handling “One Seg”, and may also occur on other terminals that perform screen displays.

On the other hand, there is a conventional technique for moving a strip-shaped area 101 (hereafter, called a caption strip) on a screen such as illustrated in FIG. 1. Moreover, there is a conventional technique for moving a rectangular area 102 (hereafter, called a caption area) on a screen such as illustrated in FIG. 1.

However, in the conventional techniques, because the area of the movement destination is replaced with the entire caption strip or the entire caption area, the video image to be originally displayed in the area of the movement destination is not displayed at all. Particularly, when the display screen is small, the video image to be originally displayed is greatly affected.

### SUMMARY

This caption movement processing apparatus includes: a caption extraction unit to identify first pixels belonging to a first portion regarded as a character string that is inserted with an overlap on a background in an expanded image generated by expanding a specific frame image included in video image data; a caption movement calculation unit to determine whether or not any one of the first pixels is out of a display area that is a part of the expanded image and to calculate a movement amount for moving the first portion so as to make all of the first pixels or at least a main portion of the first pixels accommodated in the display area when it is determined that any one of the first pixels is out of the display area; and a caption drawing unit to identify a movement destination pixel for each of the first pixels or each of pixels belonging to the character string represented by a predetermined font, according to the calculated movement amount, and to replace a color of the movement destination pixel with a predetermined color.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain conventional arts;

FIG. 2 is a diagram depicting a functional block diagram of a caption movement processing apparatus relating to this embodiment of this technique;

FIG. 3 is a diagram depicting a processing flow of the caption movement processing apparatus relating to this embodiment of this technique;

FIG. 4 is a diagram depicting a processing flow of an image expansion processing;

FIG. 5 is a diagram depicting an example of an expanded image M;

FIG. 6 is a diagram depicting a processing flow of a caption extraction processing;

FIG. 7 is a diagram depicting an example of a mask image m;

FIG. 8 is an enlarged diagram depicting part of the mask image m;

FIG. 9 is a diagram depicting a processing flow of a caption feature calculation processing;

FIG. 10 is a diagram depicting a circumscribed rectangle of a caption character portion;

FIG. 11 is a diagram depicting a processing flow (first portion) of a caption movement calculation processing;

FIG. 12 is a diagram to explain a margin area;

FIG. 13 is a diagram depicting a processing flow (second portion) of the caption movement calculation processing;

FIG. 14 is a diagram depicting processing flow (third portion) of the caption movement calculation processing;

FIG. 15 is a diagram depicting a reformed example of the caption character portion;

FIG. 16 is a diagram depicting a processing flow (first portion) of a caption generation processing;

FIG. 17 is an enlarged diagram of part of the mask image m;

FIG. 18 is a diagram depicting an example of a character image f;

FIG. 19 is a diagram depicting a processing flow (second portion) of the caption generation processing;

FIG. 20 is a diagram depicting an example of the mask image m after reforming;

FIG. 21 is a diagram depicting an example of the mask image m after reforming;

FIG. 22 is a diagram depicting a processing flow of a caption drawing processing;

FIG. 23 is a diagram depicting an example of a transformed mask image m′;

FIG. 24 is a diagram depicting an example of an output image O;

FIG. 25 is a diagram depicting a processing flow (first portion) of a caption processing;

FIG. 26 is a diagram to explain an outline of 4-neighborhood distance transformation;

FIG. 27 is a diagram to explain an outline of 8-neighborhood distance transformation;

FIG. 28 is a diagram to explain an outline of pseudo distance transformation;

FIG. 29 is an enlarged diagram of part of the transformed mask image m′;

FIG. 30 is an enlarged diagram of part of a distance-transformed image d;

FIG. 31 is a diagram depicting a processing flow (second portion) of the caption processing;

FIG. 32 is an enlarged diagram of part of an output image O after processing; and

FIG. 33 is a diagram depicting an example of the output image O.

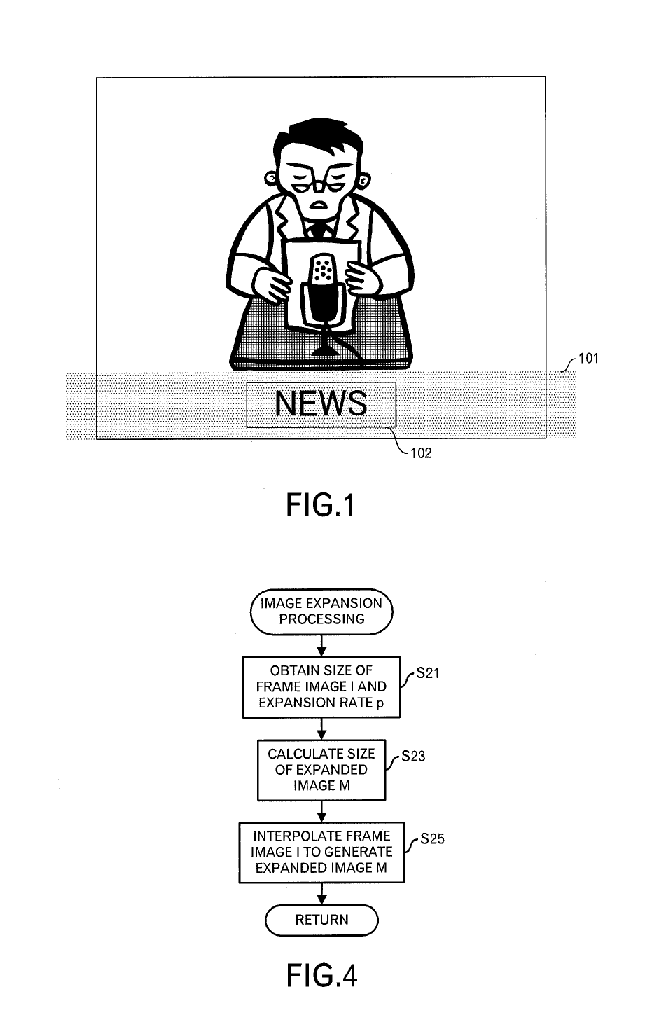

### DESCRIPTION OF EMBODIMENTS

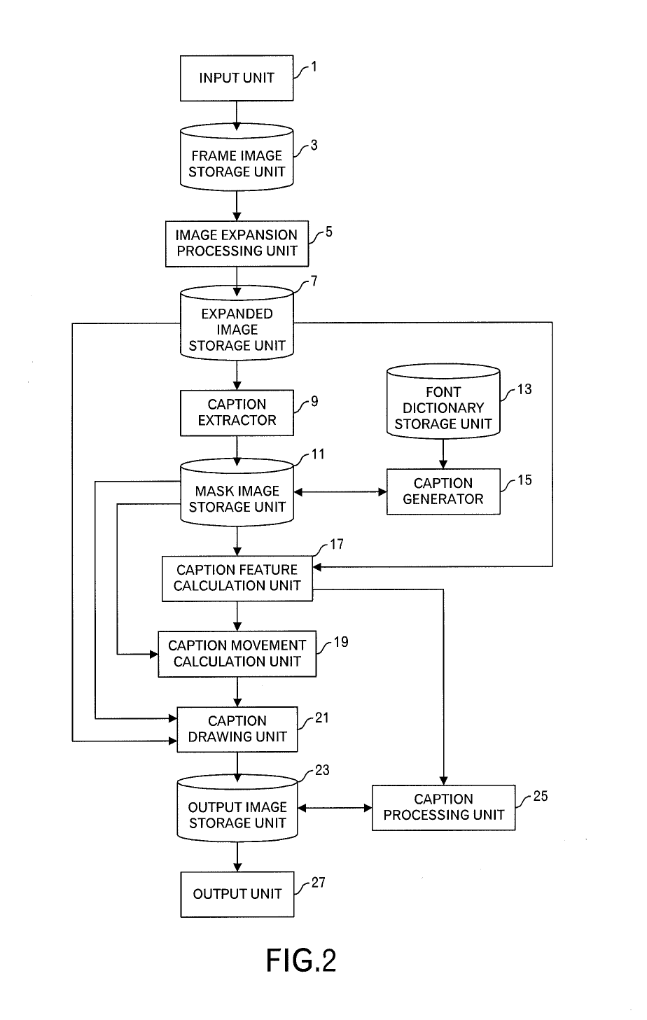

FIG. 2 depicts a function block diagram of a caption movement processing apparatus relating to an embodiment of this technique. In the example of FIG. 2, the caption movement processing apparatus has an input unit 1, a frame image storage unit 3, an image expansion processing unit 5, an expanded image storage unit 7, a caption extractor 9, a mask image storage unit 11, a font dictionary storage unit 13, a caption generator 15, a caption feature calculation unit 17, a caption movement calculation unit 19, a caption drawing unit 21, an output image storage unit 23, a caption processing unit 25 and an output unit 27.

The input unit 1 sequentially receives plural frame images relating to a certain video image, and stores those frame images into the frame image storage unit 3. The image expansion processing unit 5 uses the frame images that are stored in the frame image storage unit 3, and by performing an image expansion processing that will be explained later, the image expansion processing unit 5 generates expanded images that correspond to the frame images, then stores the expanded images into the expanded image storage unit 7. By using the expanded images that are stored in the expanded image storage unit 7 to perform a caption extraction processing that will be explained later, the caption extractor 9 extracts portions regarded as a character string that was inserted with an overlap on the background (hereafter, these may also be called “caption character potion”), then generates a mask image that will be explained later and stores the mask image into the mask image storage unit 11. The font dictionary storage unit 13 stores font dictionaries that include, for each character code, a character image of a character, which is expressed using a predetermined font. By using the mask image that is stored in the mask image storage unit 11 and the font dictionary that is stored in the font dictionary storage unit 13 to perform a font generation processing that will be explained later, the caption generator 15 updates the mask image. By using the mask image that is stored in the mask image storage unit 11 and the expanded image that is stored in the expanded image storage unit 7 to perform a caption feature calculation processing that will be explained later, the caption feature calculation unit 17 identifies the circumscribed rectangle of the caption character portion, and calculates the average color of pixels belonging to the caption character portion. By using the mask image that is stored in the mask image storage unit 11 to perform a caption movement calculation processing that will be explained later, the caption movement calculation unit 19 calculates a movement amount of the caption character portion. By using the mask image that is stored in the mask image storage unit 11 and the movement amount calculated by the caption movement calculation unit 19 to perform a caption drawing processing that will be explained later, the caption drawing unit 21 generates an output image and stores the generated output image into the output image storage unit 23. The caption processing unit 25 performs a caption processing that will be explained later on the output image that is stored in the output image storage unit 23, and updates the output image. The output unit 27 outputs the output image that is stored in the output image storage unit 23 on a display device.

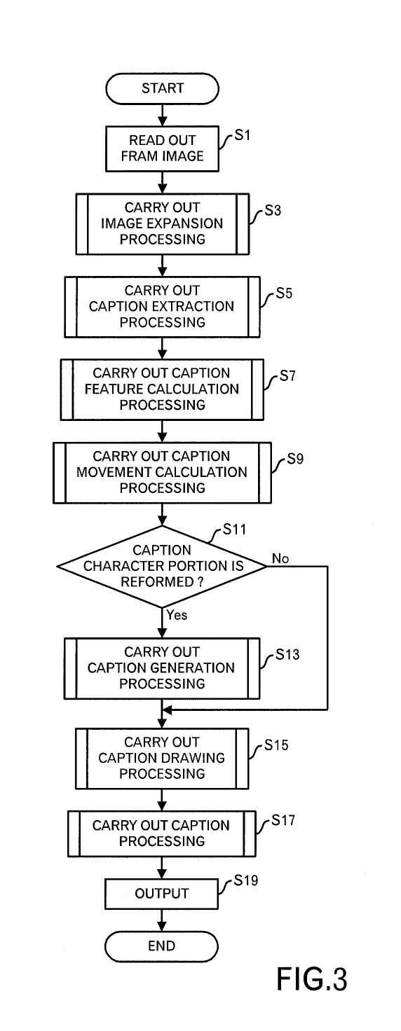

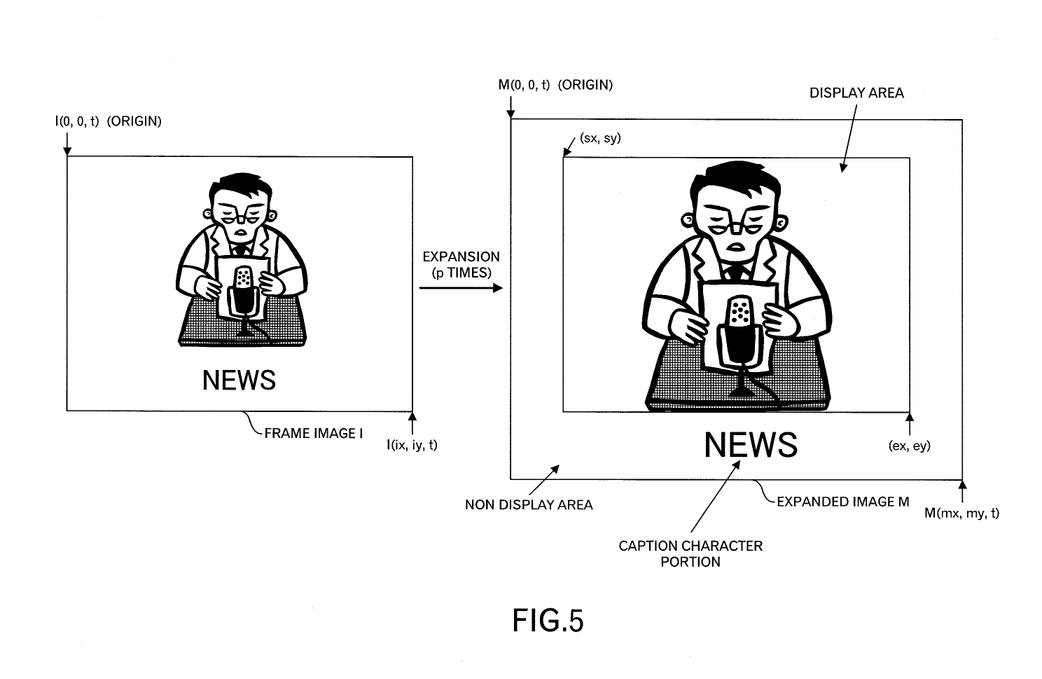

Next, the processing by the caption movement processing apparatus illustrated in FIG. 2 will be explained using FIG. 3 to FIG. 33. The entire processing flow of the caption movement processing apparatus is illustrated in FIG. 3. Incidentally, frame images that were received by the input unit 1 are stored in the frame image storage unit 3. First, the image expansion processing unit 5 reads out a frame image I of a specific time t from the frame image storage unit 3 (FIG. 3: step S1), and carries out an image expansion processing on the read frame image I (step S3). This image expansion processing will be explained using FIG. 4 and FIG. 5.

First, the image expansion processing unit 5 acquires the size of the read frame image I and the expansion rate p (FIG. 4: step S21). The expansion rate p is set, for example, according to the size of the display screen. The image expansion processing unit 5 then calculates the size of the expanded image M based on the size of the frame image I and the expansion rate p (step S23). The image expansion processing unit 5 then interpolates the frame image I and expands the fame image I at the expansion rate p to generate an expanded frame image M, and stores the expanded image M into the expanded image storage unit 7 (step S25). As for the expansion of the image, the interpolation technique such as the nearest neighbor method, bilinear method (linear interpolation method), bi-cubic method (polynomial interpolation) or the like is used. For example, when the processing of this step is carried out for the frame image I as illustrated on the left side of FIG. 5, the expanded image M as illustrated on the right side of FIG. 5 is generated. In the expanded image M in FIG. 5, a rectangle that is identified by coordinates (sx, sy) and coordinates (ex, ey) represents the range of the display target (hereafter, the area inside that rectangle will be called “the display area”, and the area outside of that rectangle will be called “the non-display area”). The image expansion processing then ends, and the processing returns to the calling-source processing.

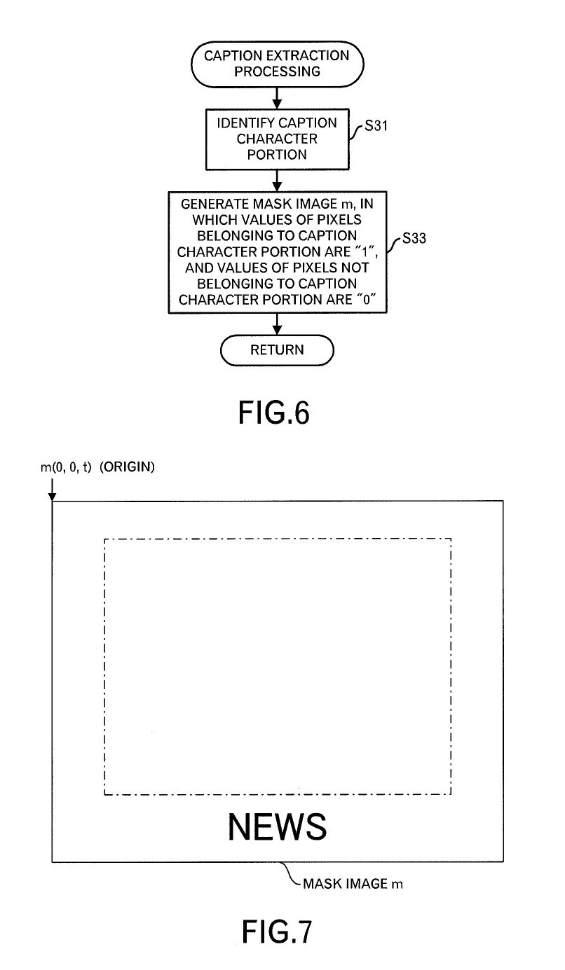

Returning to the explanation of FIG. 3, after the image expansion processing has been carried out, the caption extractor 9 uses the expanded image M that is stored in the expanded image storage unit 7 to carry out the caption extraction processing (step S5). This caption extraction processing will be explained using FIG. 6 to FIG. 8.

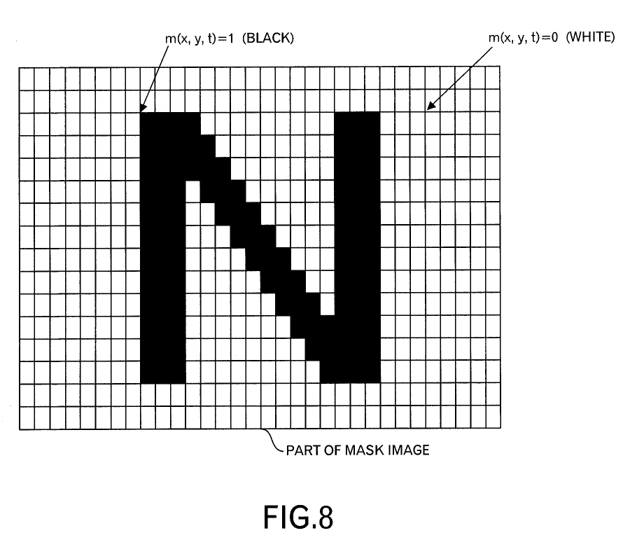

First, the caption extractor 9 identifies the caption character portion in the expanded image M (FIG. 6: step S31). In this processing, the technique disclosed in the Japanese Patent No. 3692018. The caption extractor 9 then generates a mask image m in which the value of the pixels belonging to the caption character portion are taken to be “1” and the value of other pixels (in other words, pixels not belonging to the caption character portion) is taken to be “0”, and stores the mask image m into the mask image storage unit 11 (step S33). In other words, as for the pixels that belong to the caption character portion, m(x, y, t)=1, and as for the other pixels, m(x, y, t)=0. For example, “NEWS” in the expanded image M illustrated in FIG. 5 is identified as the caption character portion, and a mask image m such as illustrated in FIG. 7 is generated. The mask image m, of which part is expanded, is illustrated in FIG. 8. In FIG. 8, the pixels that are filled with black are pixels that belong to the caption character portion. The caption extraction processing then ends, and the processing returns to the calling-source process.

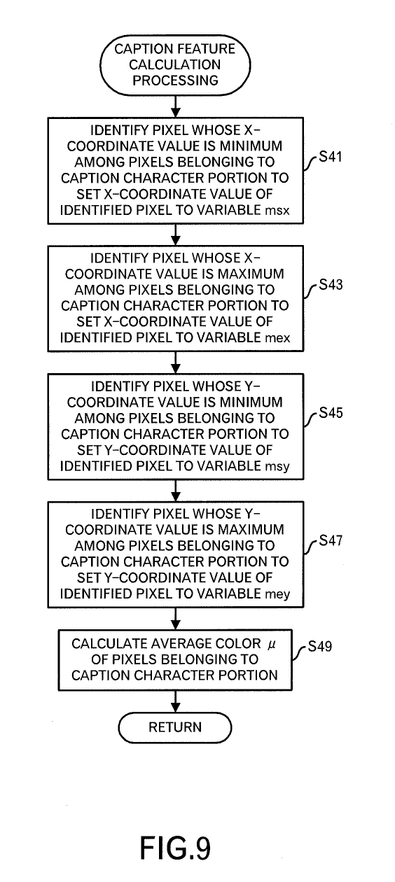

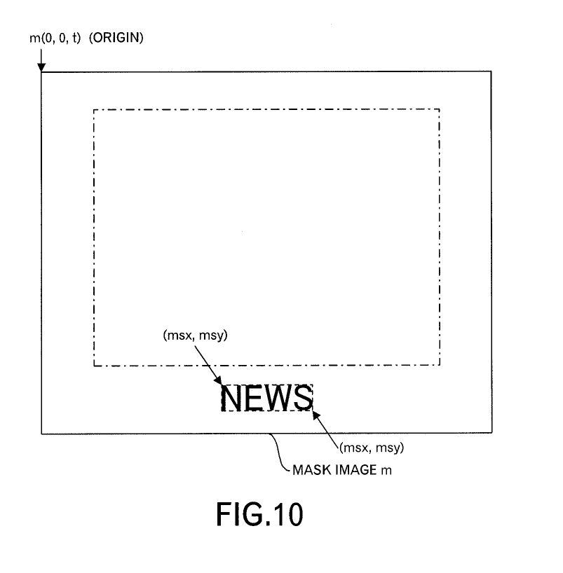

Returning to the explanation of FIG. 3, after the caption extraction processing has been performed, the caption feature calculation unit 17 uses the expanded image M that is stored in the expanded image storage unit 7 and the mask image m that is stored in the mask image storage unit 11 to perform a caption feature calculation processing (step S7). This caption feature calculation processing will be explained using FIG. 9 and FIG. 10.

First, based on the mask image m, the caption feature calculation unit 17 identifies, from among the pixels that belong to the caption character portion (in other words, pixels of which m(x, y, t)=1), pixels whose x coordinate value is the minimum, and sets the x coordinate value of the identified pixel to a variable msx (FIG. 9: step S41). In other words, the x coordinate value of the pixel on the furthest left end among the pixels that belong to the caption character portion is set to the variable msx.

The caption feature calculation unit 17 then identifies, from among the pixels that belong to the caption character portion (in other words, pixels for which m(x, y, t)=1), the pixel whose x coordinate value is the maximum based on the mask image m, and sets the x coordinate value of the identified pixel to a variable mex (step S43). In other words, the x coordinate value of the pixel on the furthest right end among the pixels that belong to the caption character portion is set to the variable mex.

The caption feature calculation unit 17 then, based on the mask image m, identifies the pixel from among the pixels that belong to the caption character section (in other words, pixels for which m(x, y, t)=1) whose y coordinate value is a minimum, and sets the y coordinate value of the identified pixel as a variable msy (step S45). In other words, the y coordinate value of the pixel on the top end among the pixels that belong to the caption character portion is set to the variable msy.

The caption feature calculation unit 17 then identifies, from among the pixels that belong to the caption character portion (in other words, pixels for which m(x, y, t)=1), the pixel whose y coordinate value is the maximum based on the mask image m, and sets the y coordinate value of the identified pixel to the variable mey (step S47). In other words, the y coordinate value of the pixel on the bottom end among the pixels that belong to the caption character portion is set to the variable mey.

When the processing of the step S41 to step S47 has been carried out, the circumscribed rectangle of the caption character portion is identified as illustrated in FIG. 10.

The caption feature calculation unit 17 then calculates the average color μ of the pixels that belong to the caption character portion and stores the calculation result into a storage device (step S49). For example, in the case of an image that is expressed using RGB, the caption feature calculation unit 17 calculates the average value of each color component, and the average color is μ=(rᵤ, gᵤ, bᵤ). The caption feature calculation processing then ends, and the processing returns to the calling-source processing.

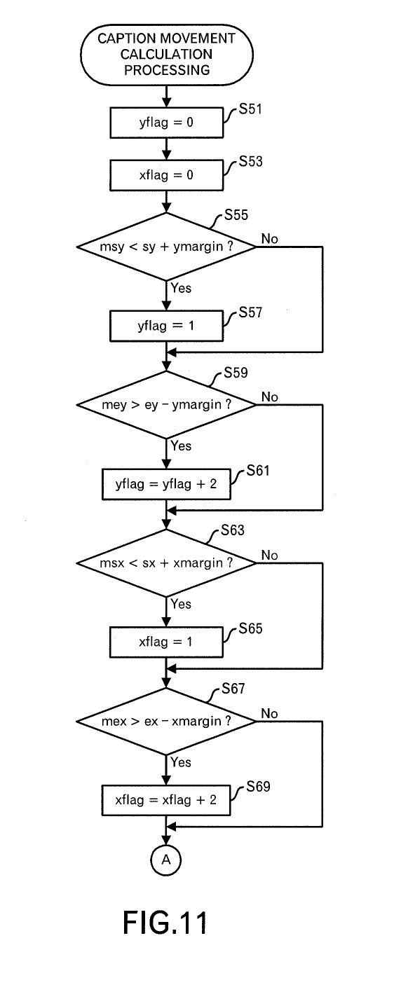

Returning to the explanation of FIG. 3, after the caption feature calculation processing has been performed, the caption movement calculation unit 19 uses the mask image m stored in the mask image storage unit 11 to carry out a caption movement calculation processing (step S9). This caption movement calculation processing will be explained using FIG. 11 to FIG. 14.

First, the caption movement calculation unit 19 sets “0” to a variable yflag (FIG. 11, step S51). The caption movement calculation unit 19 also sets “0” to a variable xflag (step S53).

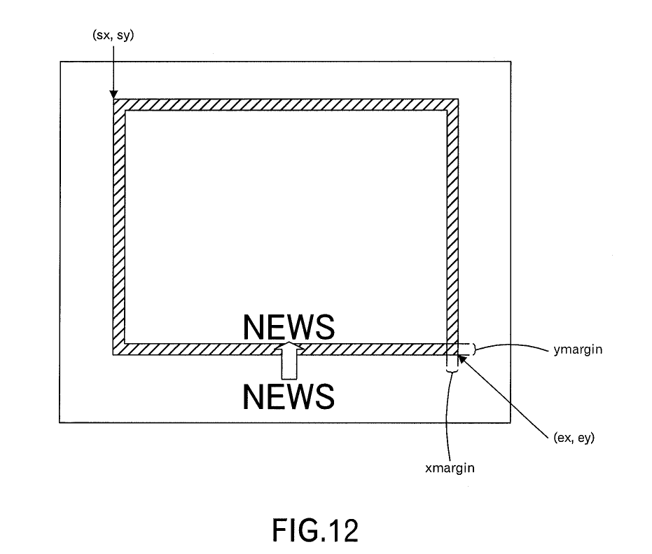

The caption movement calculation unit 19 then determines whether or not msy is less than sy+ymargin (step S55). In other words, the caption movement calculation unit 19 determines whether or not the caption character portion protrudes out in the upward direction. Here, ymargin represents the size of the margin area that is provided on the inside from the edge of the display area (top end and bottom end) in the y-axis direction, and is set beforehand. In this embodiment, the caption character portion is displayed at a position determined by an extra amount ymargin from the edge of the display area in the y-axis direction. For example, as illustrated in FIG. 12, when the caption character potion “NEWS” protrudes out in the downward direction, a margin area (the diagonal line portion in FIG. 12) having the amount ymargin is provided on the inside from the bottom end of the display area, and “NEWS” is moved so that it is not in the margin area.

When it is determined that msy is less than sy+ymargin (step S55: YES route), it is determined that the caption character portion protrudes out in the upward direction, and the caption movement calculation unit 19 sets “1” to the variable yflag (step S57). On the other hand, when it is determined that msy is equal to or greater than sy+ymargin (step S55: NO route), the processing of step S57 is skipped, and the processing moves to the processing of step S59.

The caption movement calculation unit 19 then determines whether or not mey is greater than ey−ymargin (step S59). In other words, the caption movement calculation unit 19 determines whether or not the caption character portion protrudes out in the downward direction. When mey is determined to be greater than ey−ymargin (step S59: YES route), it is determined that the caption character portion protrudes out in the downward direction, and the caption movement calculation unit 19 adds “2” to the yflag (step S61). On the other hand, when it is determined that mey is equal to or less than ey−ymargin (step S59: NO route), the processing of step S61 is skipped, and the processing moves to the processing of step S63.

Therefore, when the caption character portion protrudes out in only the upward direction, yflag becomes 1. When the caption character portion protrudes out in only the downward direction, yflag becomes 2. Furthermore, when the caption character portion protrudes out in both the upward direction and downward direction, yflag becomes 3.

The caption movement calculation unit 19 then determines whether or not msx is less than sx+xmargin (step S63). In other words, the caption movement calculation unit 19 determines whether or not the caption character portion protrudes out in the left direction. Here, the xmargin represents the size of a margin area that is provided on the inside from the left end and right end of the display area, and is set beforehand. In this embodiment, the caption character portion is displayed at a position also determined by an extra amount xmargin in the x-axis direction.

When it is determined that msx is less than sx+xmargin (step S63: YES route), it is determined that the caption character portion protrudes out in the right direction, and the caption movement calculation unit 19 sets “1” to xflag (step S65). On the other hand, when it is determined that msx is equal to or greater than sx+xmargin (step S63: NO route), the processing of step S65 is skipped, and the processing moves to the processing of step S67.

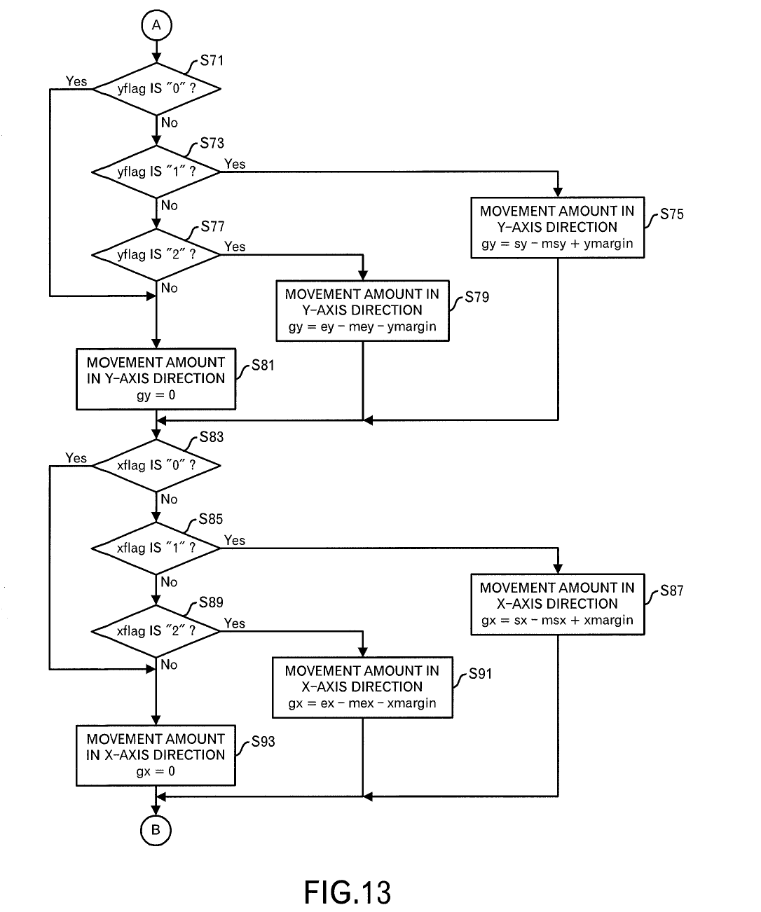

The caption movement calculation unit 19 then determines whether or not mex is greater than ex−xmargin (step S67). In other words, the caption movement calculation unit 19 determines whether or not the caption character portion protrudes out in the right direction. When it is determined that mex is greater than ex−xmargin (step S67: YES route), it is determined that the caption character portion protrudes out in the right direction, and the caption movement calculation unit 19 adds “2” to xflag (step S69). After that, the processing moves to the processing of step S71 (FIG. 13) via a terminal A. On the other hand, when it is determined that mex is equal to or less than ex−xmargin (step S67: NO route), the processing of step S69 is skipped, and the processing moves to the processing of step S71 (FIG. 13) via the terminal A.

Therefore, when the caption character portion protrudes out only in the left direction, xflag becomes 1. Moreover, when, the caption character portion protrudes out only in the right direction, xflag becomes 2. Furthermore, when the caption character portion protrudes out in both the right direction and left direction, xflag becomes 3.

Moving to explanation of FIG. 13, after the terminal A, the caption movement calculation unit 19 determines whether or not yflag is 0 (FIG. 13: step S71). When it is determined that yflag is 0 (step S71: YES route), the processing moves to the processing of step S81.

On the other hand, when it is determined that yflag is not 0 (step S71: NO route), the caption movement calculation unit 19 determines whether or not yflag is 1 (step S73). When it is determined that yflag is 1 (step S73: YES route), the caption movement calculation unit 19 calculates “sy−msy+ymargin”, and sets the calculation result to the movement amount gy in the y-axis direction (step S75). When the movement amount gy is a positive value, the value represents a movement amount in the downward direction, and when the movement value gy is a negative value, the value represents a movement amount in the upward direction. As described above, yflag becomes 1 when the caption character portion protrudes out in only the upward direction, and the movement amount gy that is set at the step S75 becomes a positive value. After that, the processing moves to step S83.

On the other hand, when it is determined that the yflag is not 1 (step S73: NO route), the caption movement calculation unit 19 determines whether or not yflag is 2 (step S77). When it is determined that yflag is 2 (step S77: YES route), the caption movement calculation unit 19 calculates “ey−mey−ymargin”, and sets the calculation result to the movement amount gy in the y-axis direction (step S79). As described above, yflag is 2 when the caption character portion protrudes out only in the downward direction, and the movement amount gy that is calculated at the step S79 is a negative value. After that, the processing moves to the step S83.

On the other hand, when it is determined that yflag is not 2 (step S77: NO route), in other words, when yflag is 3, the caption movement calculation unit 19 sets “0” to the movement amount gy in the y-axis direction (step S81). Even when yflag is determined to be 0 at the step S71, the processing of this step is carried out. As described above, yflag is 3 when the caption character portion protrudes out in both the upward and downward direction. On the other hand, yflag is 0 when the caption character portion does not protrude out in either the upward direction or downward direction. In these cases, because it is meaningless to move the caption character portion in the y-axis direction, “0” is set to the movement amount gy.

The caption movement calculation unit 19 determines whether or not xflag is 0 (step S83). When it is determined that xflag is 0 (step S83: YES route), the processing moves to step S93.

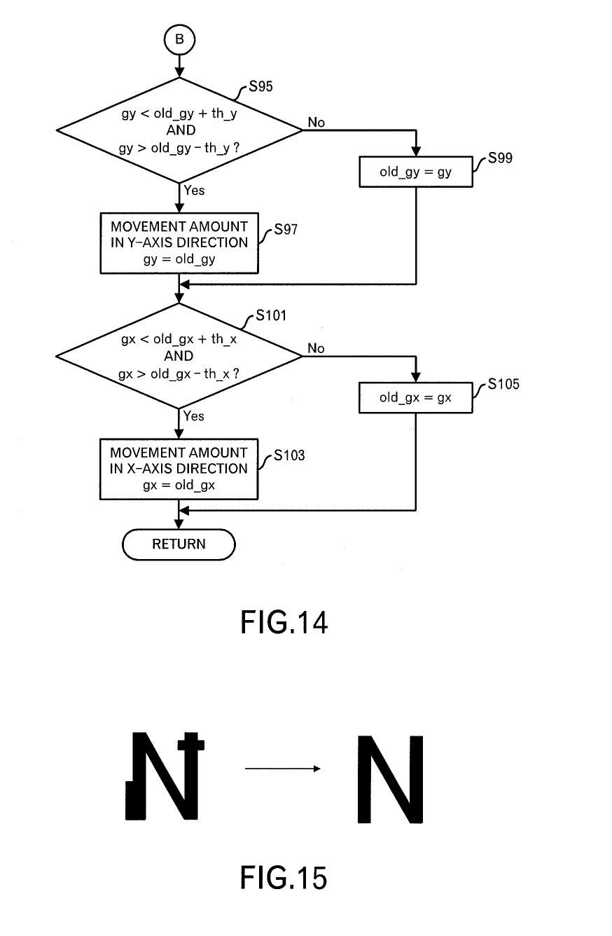

On the other hand, when it is determined that xflag is not 0 (step S83: NO route), the caption movement calculation unit 19 determines whether or not xflag is 1 (step S85). When it is determined that xflag is 1 (step S85: YES route), the caption movement calculation unit 19 calculates “sx−msx+xmargin”, and sets the calculation result to the movement amount gx in the x-axis direction (step S87). When the movement amount gx is a positive value, the value represents a movement amount in the right direction, and when the movement amount gx is a negative value, the value represents a movement amount in the left direction. As described above, xflag is 1 when the caption character portion protrudes out only in the left direction, and the movement amount gx, which is set at the step S87, is a positive value. After that, the processing moves to the processing of step S95 (FIG. 14) via a terminal B.

On the other hand, when it is determined that xflag is not 1 (step S85: NO route), the caption movement calculation unit 19 determines whether or not xflag is 2 (step S89). When it is determined that xflag is 2 (step S89: YES route), the caption movement calculation unit 19 calculates “ex−mex−xmargin”, and sets the calculation result to the movement amount gx in the x-axis direction (step S91). As described above, xflag is 2 when the caption character portion protrudes out only in the right direction, and the movement amount gx, which is calculated at the step S91, is a negative value. After that, processing moves to the processing of step S95 (FIG. 14) via the terminal B.

On the other hand, when it is determined that xflag is not 2 (step S89: NO route), in other words, when xflag is 3, the caption movement calculation unit 19 sets “0” to the movement amount gx in the x-axis direction (step S93). When it was determined even at the step S83 that xflag is 0, the processing of this step is carried out. As described above, xflag is 3 when the caption character portion protrudes out in both the left direction and right direction. On the other hand, xflag is 0 when the caption character portion does not protrude in either left direction or right direction. In these cases, because movement in the x-axis direction is meaningless, 0 is set to the movement amount gx is set.

Moving to explanation of FIG. 14, after the terminal B, the caption movement calculation unit 19 determines whether or not the condition that gy is less than old_gy+th_y, and gy is greater than old_gy−th_y is satisfied (FIG. 14: step S95). Here, old_gy represents the movement amount in the y-axis direction for the previous frame image (in other words, the frame image at time (t-1)). In other words, at the step S95, the caption movement calculation unit 19 determines whether or not the difference between gy and old_gy is less than a predetermined threshold value th_y. When the condition that gy is less than old_gy+th_y, and gy is greater than old_gy−th_y is satisfied (step S95: YES route), the caption movement calculation unit 19 sets old_gy to gy (step S97). In this embodiment, in order to prevent the caption after the movement from flickering, the movement amount old_gy of the previous frame image is used as the movement amount gy when the difference between the movement amount gy and the movement amount old_gy of the previous frame image is less than a predetermined threshold value th_y. The processing then moves to the processing of step S101.

On the other hand, when the condition that gy is less than old_gy+th_y, and gy is greater than old_gy−th_y is not satisfied (step S95: NO route), the caption movement calculation unit 19 sets old_gy to gy (step S99). In other words, for a processing of the next frame image (in other word, the frame image at time (t+1)), gy is stored as old_gy. The processing then moves to the processing of step S101.

The caption movement calculation unit 19 then determines whether or not the condition that gx is less than “old_gx+th_x”, and gx is greater than “old_gx−th_x” is satisfied (step S101). Here, old_gx is the movement amount of the previous frame image in the x-axis direction. In other words, at the step S101, the caption movement calculation unit 19 determines whether or not the difference between gx and old_gx is less than a predetermined threshold value th_x. When the condition that gx is less than “old_gx+th_x”, and gx is greater than “old_gx−th_x” is satisfied (step S101: YES route), the caption movement calculation unit 19 sets old_gx to gx (step S103). In this embodiment, in order to prevent the caption after the movement from flickering, when the difference between the movement amount gx and the movement amount old_gx of the previous frame image is less than the predetermined threshold value th_x, the movement amount old_gx of the previous frame image is used as the movement amount gx. The caption movement calculation processing then ends, and the processing returns to the calling-source processing.

On the other hand, when the condition that gx is less than “gx+th_x”, and gx is greater than “old_gx−th_x” is not satisfied (step S101: NO route), the caption movement calculation unit 19 sets gx to old_gx (step S105). In other words, for the processing of the next frame image, gx is stored as old_gx. The caption movement calculation processing then ends, and the processing returns to the calling-source processing.

By performing the processing such as described above, it is possible to calculate the movement amount in the x-axis direction and y-axis direction. Moreover, when the difference between the calculated movement amount and the movement amount of the previous frame image is small, the movement amount of the previous frame image is used. Therefore, it is possible to prevent the display of the caption character portion after the movement from flickering.

Returning to the explanation of FIG. 3, after the caption movement calculation processing has been performed, the caption generator 15 determines whether or not the caption character portion is reformed (step S11). It is assumed that whether or not the caption character portion is reformed is set beforehand by the user. When it is determined that the caption character portion is not reformed (step S11: NO route), the processing of the step S13 is skipped, and the processing moves to the processing of step S15.

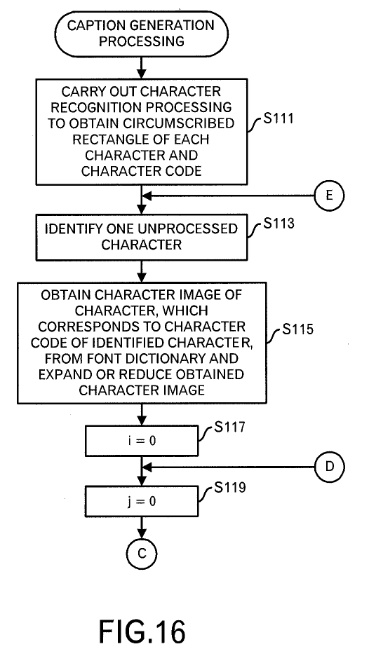

On the hand, when it is determined that the caption character portion is reformed (step S11: YES route), the caption generator 15 uses the mask image m that is stored in the mask image storage unit 11, and the font dictionary that is stored in the font dictionary storage unit 13 to carry out a caption generation processing (step S13). As illustrated in FIG. 15, in the caption generation processing, a processing is carried out in order to replace each of the characters in the caption character portion with a character that is expressed using a predetermined font. The caption generation processing will be explained using FIG. 16 to FIG. 21.

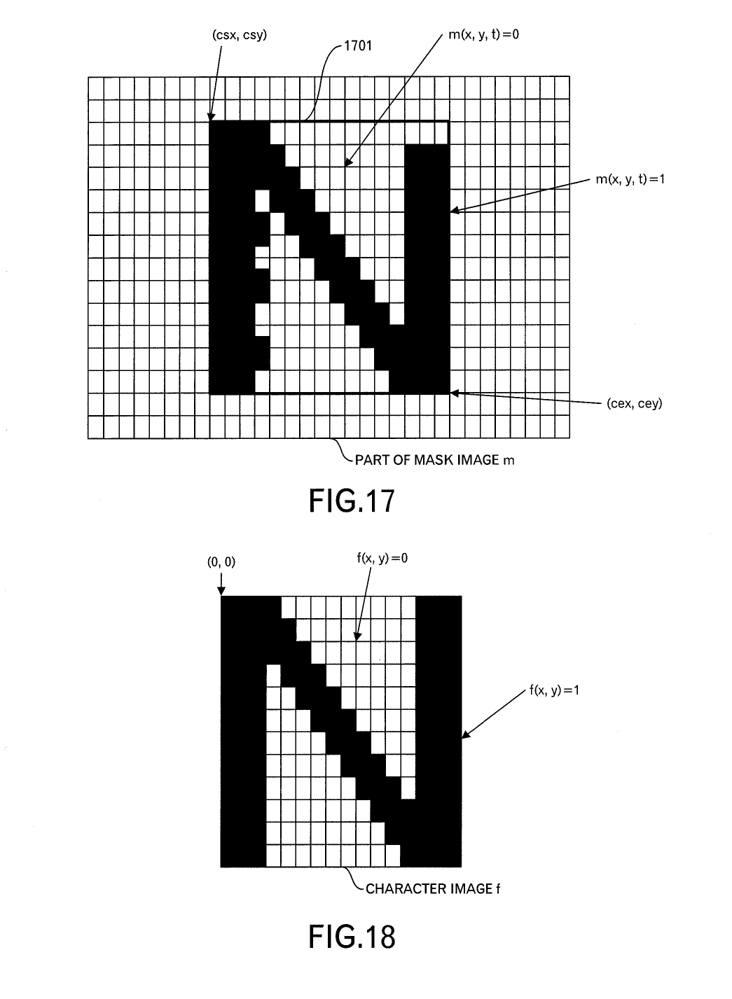

First, the caption generator 15 uses the mask image m to carry out a character recognition processing on the caption character portion, and acquires the circumscribed rectangle and character code of each character (FIG. 16: step S111). Part of the mask image m is illustrated in FIG. 17. For example, when the character recognition processing is performed for pixels of which m(x, y, t)=1, the character code corresponding to “N”, and the circumscribed rectangle 1701 for the character “N” are obtained. In the following, below the coordinates of the upper left vertex of the circumscribed rectangle 1701 are taken to be (csx, csy), and the coordinates of the lower right vertex are taken to be (cex, cey). The character recognition processing is the same as a conventional processing, so it will not be explained here.

The caption generator 15 then identifies an unprocessed character from among characters that are included in the caption character portion (step S113). The caption generator 15 then acquires the character image f of a character that corresponds to the character code of the identified character from the font dictionary, and expands or reduces the size of the acquired character image f so that the size of the character image f matches with the size of the circumscribed rectangle of the identified character (step S115). An example of the character image f is illustrated in FIG. 18. The character image f in FIG. 18 is expanded or reduced so that the size of the character image f matches with the size of the circumscribed rectangle 1701 illustrated in FIG. 17. The values of pixels that belong to the character are “1” and the values of the other pixels are “0”.

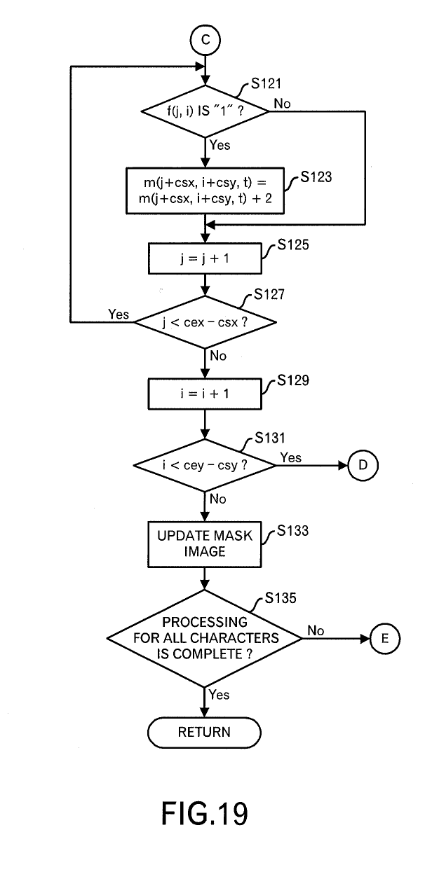

The caption generator 15 then sets “0” to the counter i (step S117). The caption generator 15 also sets “0” to the counter j (step S119). Then, the processing moves to the processing of step S121 (FIG. 19) via a terminal C.

Moving to explanation of FIG. 19, after the terminal C, the caption generator 15 determines whether f(j, i) is “1” (FIG. 19: step S121). When it is determined that f(j, i) is “1” (step S121: YES route), the caption generator 15 adds “2” to m(j+csx, i+csy, t) (step S123). The caption generator 15 increments the counter j by “1” (step S125), and determines whether or not counter j is less than “cex−csx” (step S127). When it is determined that counter j is less than “cex−csx” (step S127: YES route), the processing returns to the step S121, and the processing from the step S121 to the step S127 is repeated.

On the other hand, when it is determined that counter j is equal to or greater than “cex−csx” (step S127: NO route), the caption generator 15 increments counter i by “1” (step S129), and determines whether or not the counter i is less than “cey−csy” (step S131). When it is determined that the counter i is less than “cey−csy” (step S131: YES route), the processing returns to the processing of the step S119 (FIG. 16) via a terminal D, and the processing from the step S119 to the step S131 is repeated.

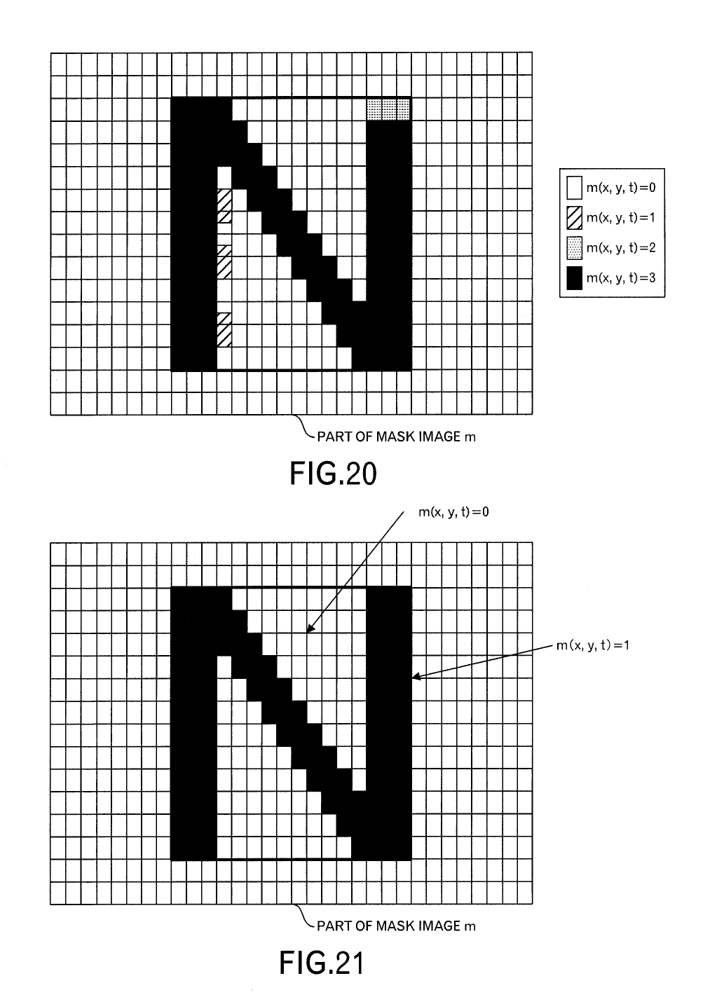

For example, when the processing such as described above is carried out on part of the mask image m using the character image f illustrated in FIG. 18, the mask image m becomes an image as illustrated in FIG. 20. In FIG. 20, the pixels whose pixel value is “0” (in other words, m(x, y, t)=0) are pixels that do not belong to the caption character portion before and after reforming. Moreover, the pixels whose pixel value is “1” (in other words, m(x, y, t)=1) are pixels that belong to the caption character portion before reforming, however, no longer belong to the caption character portion after reforming. Furthermore, pixels whose pixel value is “2” (in other words, m(x, y, t)=2) are pixels that did not belong to the caption character portion before reforming, but are pixels that belong to the caption character portion after reforming. Moreover, pixels whose pixel value is “3” (in other words, m(x, y, t)=3) are pixels that belong to the caption character portion before and after reforming. In other words, the pixels value is one of “0” to “3”.

On the other hand, when it is determined that i is equal to or greater than “cey−csy” (step S131: NO route), the caption generator 15 updates the mask image m (step S133). In this processing, as for each of the pixels whose pixel value is “1”, the pixel values of those pixels are changed to “0”. Moreover, as for each of the pixels whose pixel value is “2” or “3”, the pixel values of those pixels are changed to “1”. For example, the processing of this step is carried out for the mask image m illustrated in FIG. 20, and the mask image becomes an image as illustrated in FIG. 21.

The caption generator 15 then determines whether or not the processing is complete for all characters (step S135). When the processing is not complete for all characters (step S135: NO route), the processing returns to the processing of step S113 (FIG. 16) via a terminal E. On the other hand, when processing is complete for all characters (step S135: YES route), the caption generation processing ends, and the processing returns to the calling-source processing.

By carrying out the processing as described above, it is possible to display captions in an output image with characters, which are easy to view as will be described below, even when bleeding of the characters or the like occur due to the expansion of the video image, for example.

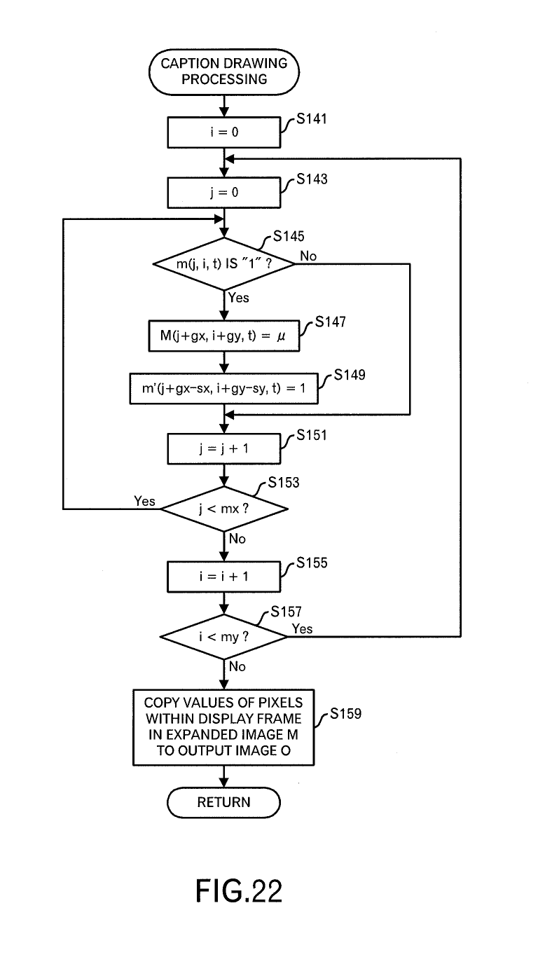

Returning to the explanation of FIG. 3, when it is determined at the step S11 that the caption character portion is not reformed, or after the caption generation processing, the caption drawing unit 21 uses the expanded image M that is stored in the expanded image storage unit 7, the mask image m that is stored in the mask image storage unit 11, and the movement amounts gx and gy to carry out the caption drawing processing (step S15). The caption drawing processing will be explained using FIG. 22 to FIG. 24.

First, the caption drawing unit 21 generates a transformed mask image m′, which has the same size as that of the output image O and stores the generated image into the output image storage unit 23. At this point, the value of each of the pixels in the output image O and the value of each of the pixels in the transformed mask image m′ are all “0”. The caption drawing unit 21 then sets a counter i to “0” (FIG. 22: step S141). Also, the caption drawing unit 21 sets a counter j to “0” (step S143).

The caption drawing unit 21 determines whether or not m(j, i, t) is “1” (step S145). When it is determined that m(j, i, t) is “1” (step S145: YES route), the caption drawing unit 21 sets the average color μ to M(j+gx, j+gy, t) (step S147). In other words, the color of the pixels at the movement destination in the expanded image M is replaced with the average color μ. The pixels at the movement destination are identified by moving from the current position by an amount gx in the x-axis direction, and an amount gy in the y-axis direction.

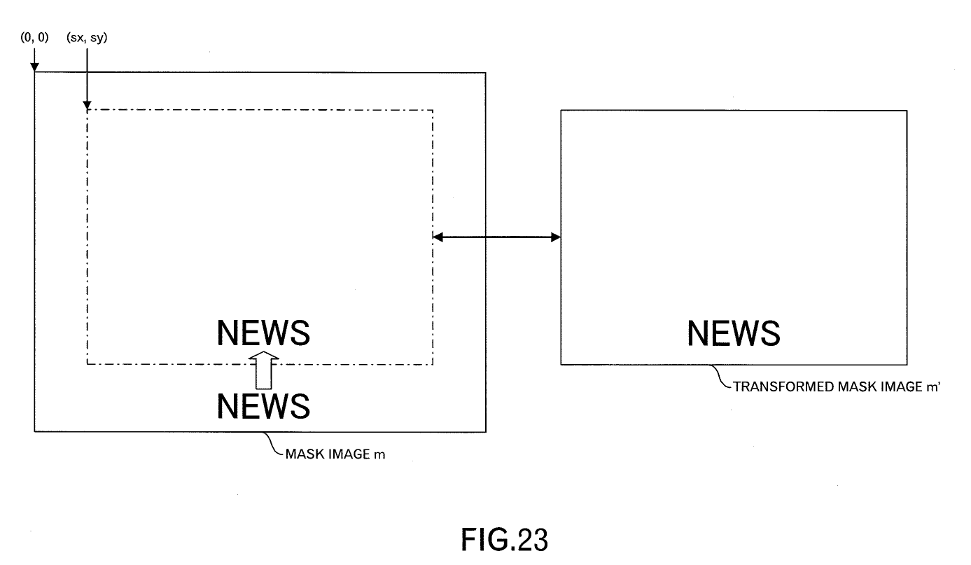

The caption drawing unit 21 then sets “1” to m′(j+gx−sx, i+gy−sy, t) (step S149). In other words, “1” is set to the pixels at the movement destination in the transformed mask image m′. Here, the reason for subtracting sx and sy is that, as illustrated in FIG. 23, in the mask image m and transformed mask image m′, the position of the origin has shifted an amount sx in the x-axis direction, and has shifted an amount sy in the y-axis direction. The transformed mask image m′ is used in the caption processing that will be explained later.

On the other hand, when it is determined that m(j, i, t) is not “1” (step S145: NO route), the processing of the steps S147 and S149 is skipped, and the processing moves to the processing of step S151.

Then, the caption drawing unit 21 increments the counter j by “1” (step S151), and determines whether or not the counter j is less than mx (step S153). When it is determined that counter j is less than mx (step S153: YES route), the processing returns to the processing of step S145, and the processing from the step S145 to step S153 is repeated.

However, when it is determined that counter j is equal to or greater than mx (step S153: NO route), the caption drawing unit 21 increments the counter i by “1” (step S155), and determines whether or not the counter i is less than my (step S157). When it is determined that counter i is less than my (step S157: YES route), the processing returns to the processing of step S143, and the processing from the step S143 to step S157 is repeated.

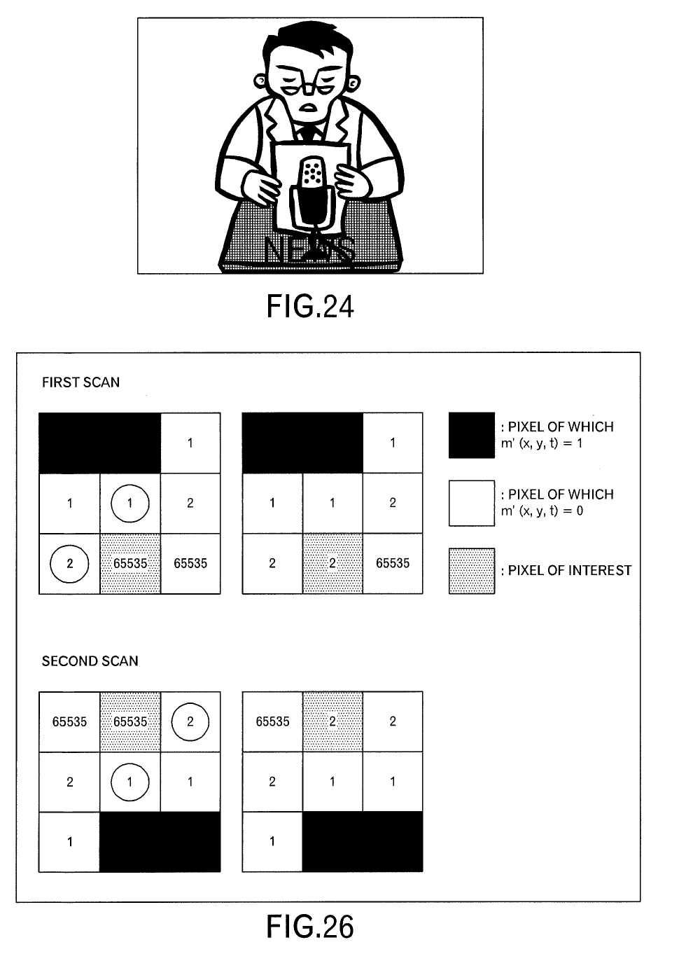

On the other hand, when it is determined that i is equal to or greater than my (step S157: NO route), the caption drawing unit 21 copies the values of the pixels in the display area of the expanded image M to the output image O (step S159). For example, an example of the output image O is illustrated in FIG. 24. When the aforementioned processing is carried out for the expanded image M illustrated in FIG. 5, for example, the output image O such as illustrated in FIG. 24 is generated. In FIG. 24, only the pixels belonging to the caption character portion “NEWS” is moved, and the pixels other than those belonging to “NEWS” are displayed as in the original image. The caption drawing processing then ends, and the processing returns to the calling-source processing.

By performing the processing such as described above, it is possible to generate the output image O in which only the pixels belonging to the caption character portion are moved. In other words, it is possible to display captions while keeping any effect on the image to be originally displayed to the minimum. When there are pixels for which m(j, i, t)=1 in the display area, the caption character portion before the movement is not displayed in the output image O by setting the average color of the pixels surrounding those pixels to M(j, i, t).

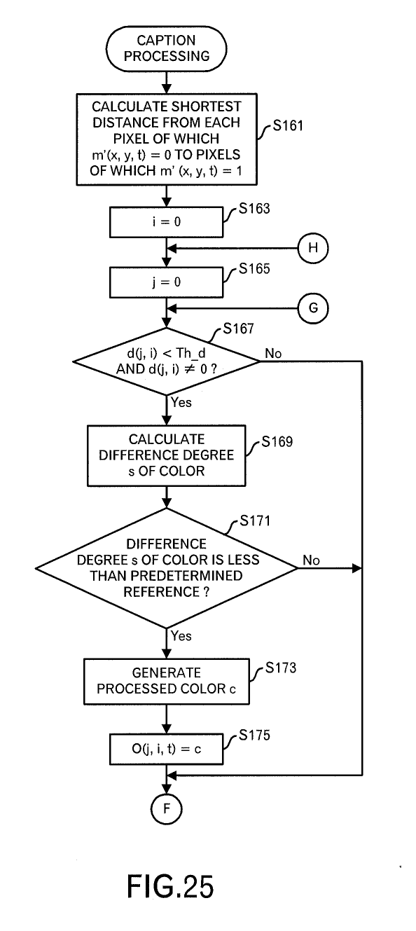

Returning to the explanation of FIG. 3, after the caption drawing processing has been performed, the caption processing unit 25 performs the caption processing on the output image that is stored in the output image storage unit 23 (step S17). The caption processing will be explained using FIG. 25 to FIG. 33.

First, the caption processing unit 25 reads out the transformed mask image m′ from the output image storage unit 23. Then, for each of the pixels of which m′(x, y, t)=0, the caption processing unit 25 calculates the shortest distance from those pixels to the pixels of which m′(x, y, t)=1 (FIG. 25: step S161). For example, this shortest distance can be calculated by 4-neighborhood distance transformation, 8-neighborhood distance transformation, pseudo distance transformation or the like. Here, an image having the distance values as pixel values is called a distance-transformed image d.

For example, FIG. 26 illustrates 4-neighborhood distance conversion. First, as for pixels of which m′(x, y, t)=1, d(x, y)=0 is set, and as for pixels of which m′(x, y, t)=0, d(x, y)=max_value (for example, 65535) is set. Then, for each of the pixels of which d(x, y)≠0, scanning is performed from the upper left (i.e. first scan). In the following, the pixel of interest is d(x, y). More specifically, the minimum value is identified from among d(x, y), d(x−1, y)+1 and d(x, y−1)+1, and is set to d(x, y). For example, in the first scan illustrated in FIG. 26, d(x, y)=65535, d(x−1, y)+1=2+1=3 and d(x, y−1)+1=1+1=2, so the minimum value “2” is set to d(x, y). After the first scan has been completed for all pixels, scanning (second scan) is carried out from the lower right for each of the pixels of which d(x, y)≠0. More specifically, the minimum value is identified from among d(x, y), d(x+1, y)+1 and d(x, y+1)+1, and is set to d(x, y). For example, in the second scan illustrated in FIG. 26, d(x, y)=65535, d(x+1, y)+1=2+1=3 and d(x, y+1)+1=1+1=2, so the minimum value “2” is set to d(x, y). By performing processing such as described above, the distance-transformed image d is generated.

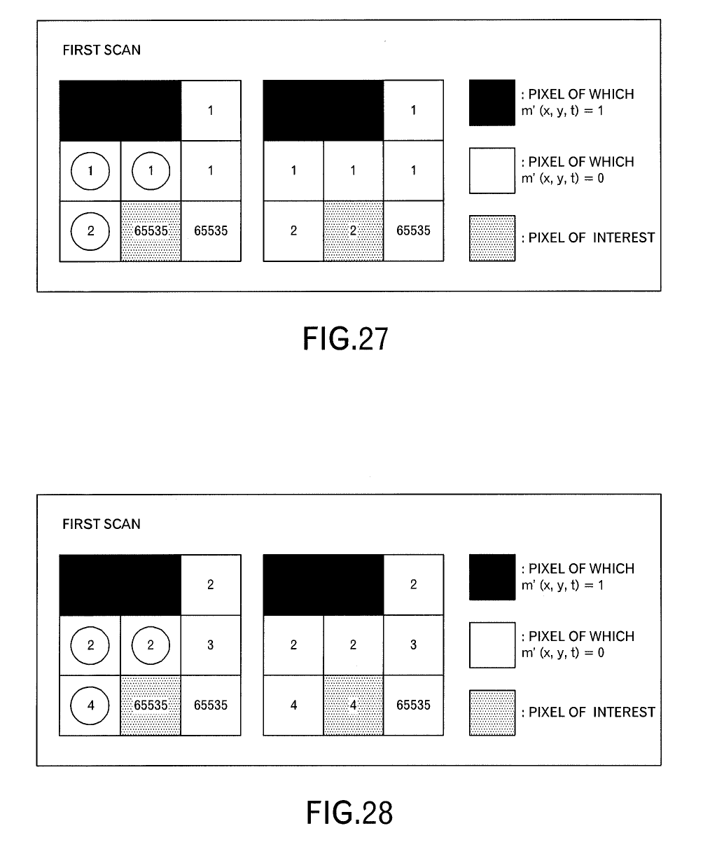

Moreover, FIG. 27 illustrates 8-neighborhood distance transformation. Basically, this is the same as 4-neighborhood distance transformation, however, in the case of 8-neighborhood distance transformation, in the first scan, taking into consideration the pixel d(x−1, y−1) on the upper left of the pixel of interest, the minimum value is identified from among d(x, y), d(x−1, y)+1, d(x, y−1)+1, d(x−1, y−1)+1 and is set to d(x, y). For example, in the first scan in FIG. 27, d(x, y)=65535, d(x−1, y)+1=2+1=3, d(x, y−1)+1=1+1=2 and d(x−1, y−1)+1=1+1=2, so the minimum value “2” is set to d(x, y). In the second scan, taking into consideration the pixel d(x+1, y+1) on the lower left of the pixel of interest, the minimum value is identified from among d(x, y), d(x+1, y)+1, d(x, y+1)+1 and d(x+1, y+1)+1, and is set to d(x, y).

Furthermore, FIG. 28 illustrates an outline of pseudo distance transformation. Basically, this is the same as 4-neighborhood distance transformation, however, in the case of the pseudo distance transformation, the vertical and horizontal distance interval is taken to be “2”, and the diagonal distance interval is taken to be “3”. Therefore, in the first scan, the minimum value is identified from among d(x, y), d(x−1, y)+2, d(x, y−1)+2 and d(x−1, y−1)+3, and is set to d(x, y). For example, in the first scan illustrated in FIG. 28, d(x, y)=65535, d(x−1, y)+2 =4+2=6, d(x, y−1)+2=2+2=4 and d(x−1, y−1)+3=2+3=5, so the minimum value “4” is set to d(x, y). In the second scan, the minimum value is identified from among d(x, y), d(x+1, y)+2, d(x, y+1)+2 and d(x+1, y+1)+3, and is set to d(x, y). Finally, the distance is calculated by dividing each d(x, y) by “2”.

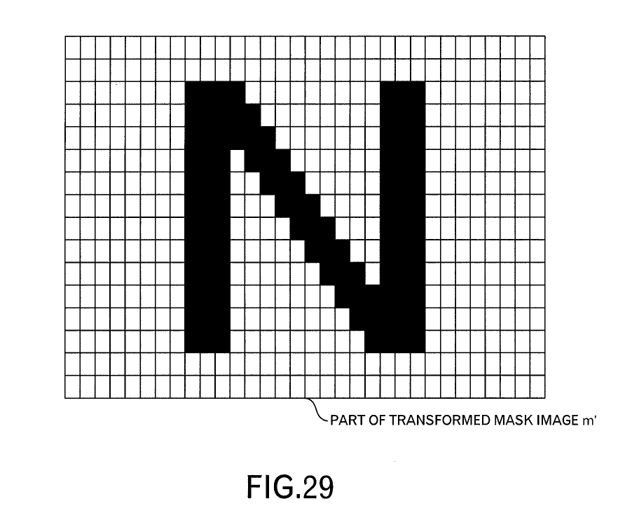

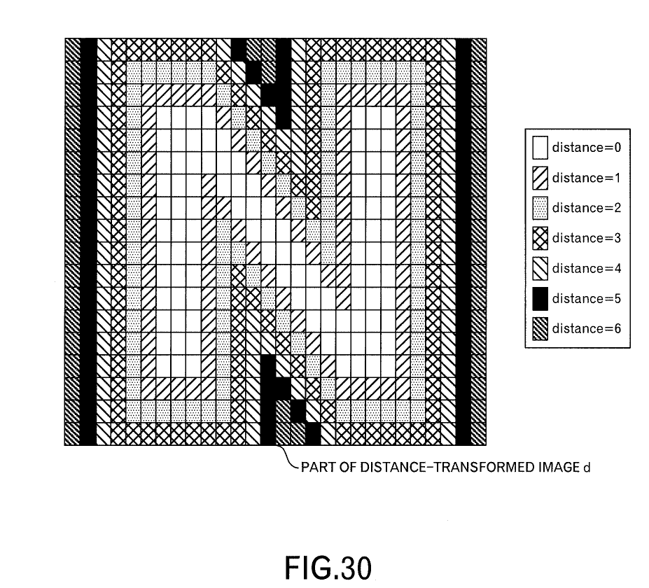

The shortest distance may be calculated using another method. For example, it is assumed that the processing of step S161 is carried out for the transformed mask image m′ illustrated in FIG. 29, and a distance-transformed image d illustrated in FIG. 30 is generated, the processing will be explained below.

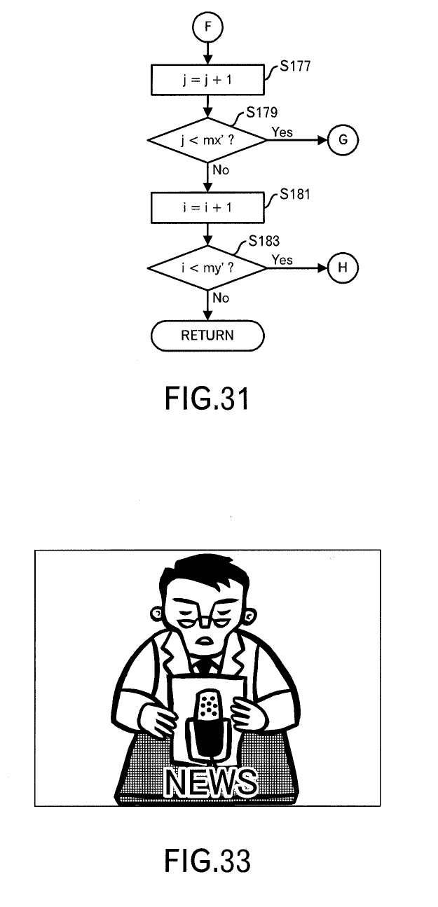

The caption processing unit 25 sets a counter i to “0” (step S163). The caption processing unit 25 also sets a counter j to “0” (step S165). The caption processing unit 25 then determines whether or not the condition that d(j, i) is less than a predetermined threshold value Th_d and d(j, i) is equal to or greater than “0” is satisfied (step S167). When it is determined that the condition that d(j, i) is less than the predetermined threshold value Th_d and d(j, i) is equal to or greater than “0” is not satisfied (step S167: NO route), the processing from step S169 to step S175 is skipped, and the processing moves to the processing of step S177 (FIG. 31) via a terminal F.

On the other hand, when it is determined that the condition that d(j, i) is less than a predetermined threshold value Th_d and d(j, i) is equal to or greater than “0” is satisfied (step 5167: YES route), the caption processing unit 25 calculates the color difference degree s (step S169). When the color is expressed by RGB, for example, the color difference degree s can be calculated as s=|r−rᵤ|+|g−gᵤ|+|b−bᵤ|. Here, r, g and b represent the color components of O(j, i, t) and rᵤ, gᵤ and bᵤ represent the color components of the average color μ.

The caption processing unit 25 then determines whether or not the color difference degree s is less than a predetermined reference value (step S171). When it is determined that the color difference degree s is equal to or greater than the predetermined reference value (step S171: NO route), the processing of step S173 and step S175 is skipped, and the processing moves to the processing of step S177 (FIG. 31) via the terminal F.

On the other hand, when it is determined that the color difference degree s is less than the predetermined reference value (step S171: YES route), the caption processing unit 25 generates a processed color c (step S173), and sets that processed color c to O(j, i, t) (step S175). For example, when the processed color c is taken to be (r_{c}, g_{c, b}_{c}), each color component can be calculated by r_{c}=mod(r+128, 255), g_{c}=mod(g+128, 255) and b_{c}=mod(b+128, 255). Thus, it is possible to replace the color of O(j, i, t) with the opposite color of O(j, i, t) (in other words, color whose difference of RGB value is 128). In addition, each color component may be calculated by r_{c}=mod(rᵤ+128, 255), g_{c}=mod(gᵤ+128, 255) and b_{c}=mod(bᵤ+128, 255). Thus, it is possible to replace the color of O(j, i, t) with the opposite color of the average color μ. After that, the processing moves to the processing of step S177 (FIG. 31) via the terminal F.

Moving to an explanation of FIG. 31, after the terminal F, the caption processing unit 25 increments counter j by 1 (FIG. 31: step S177), and determines whether counter j is less than mx′ (step S179). Here mx′ is the horizontal width of the output image O. When it is determined that counter j is less than mx′ (step S179: YES route), the processing returns to the processing of step S167 (FIG. 25) via a terminal G, and the processing from step S167 to step S179 is repeated.

On the other hand, when it is determined that the counter j is equal to or greater than mx′ (step S179: NO route), the caption processing unit 25 increments the counter i by “1” (step S181), and determines whether or not the counter i is less than my′ (step S183). Here, my′ is the height of the output image O. When it is determined that the counter i is less than my′ (step S183: YES route), the processing returns to the processing of step S165 (FIG. 25) via a terminal H, and the processing from step S165 to step S183 is repeated.

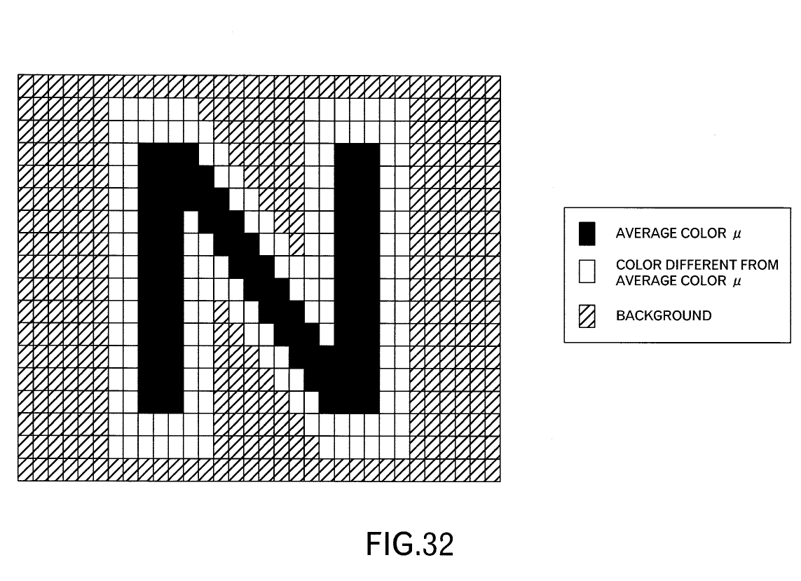

On the other hand, when it is determined that the counter i is equal to or greater than my′ (step S183: NO route), the caption processing ends, and the processing returns to the calling-source processing. For example, when the surrounding pixels having a distance of 2 or less are transformed according to the distance-transformed image d illustrated in FIG. 30, the output image O becomes an image as illustrated in FIG. 32.

By performing a processing such as described above, a border is formed for each character of the caption character portion using a color that is different from the character color. Therefore, it becomes possible to make it easy to see the caption after the movement.

Returning to the explanation of FIG. 3, after the caption processing has been performed, the output unit 27 outputs the output image O that is stored in the output image storage unit 23 to the display (step S19), and the processing ends. For example, after the processing such as described above has been performed for the frame image I illustrated in FIG. 5, the output image O such as illustrated in FIG. 33 is generated and displayed. In FIG. 33, a border is formed around the caption characters portion “NEWS” so that it is easy to see.

Although one embodiment of this technique was explained, this technique is not limited to this. For example, the functional block diagram of the aforementioned caption movement processing apparatus does not always correspond to an actual program module configuration. Furthermore, in the processing flows, as long as the processing results do not change, the order of the steps may be exchanged. Moreover, the steps may be executed in parallel.

Although an example was explained of calculating the movement amount in order that all of the pixels that belong to a caption character portion fit within a display area, it is not absolutely necessary that all of the pixels that belong to the caption character portion fit within the display area. For example, as long as the caption character portion is recognizable even though some of the pixels that belong to the caption character portion are missing, it is possible to calculate the movement amount so that the main pixels except for part of the pixels fit.

Moreover, although an example was explained above in which the caption generation processing was performed after the caption movement calculation processing, the caption generation processing can be performed first. In this case, the movement amount can be calculated based on the reformed caption character portion.

Incidentally, it is possible to create a program for realizing the caption movement processing apparatus with the hardware such as a computer, and such a program is stored in a storage medium or storage device, such as flexible disk, CD-ROM, magneto-optical disk, semiconductor memory, hard disk and the like. Moreover, the intermediate processing results are stored in the storage device such as a main memory.

This embodiment is outlined as follows:

A caption movement processing apparatus of the embodiment includes: a caption extraction unit to identify first pixels belonging to a first portion regarded as a character string that is inserted with an overlap on a background in an expanded image generated by expanding a specific frame image included in video image data; a caption movement calculation unit to determine whether or not any one of the first pixels is out of a display area that is a part of the expanded image and to calculate a movement amount for moving the first portion so as to make all of the first pixels or at least a main portion of the first pixels accommodated in the display area when it is determined that any one of the first pixels is out of the display area; and a caption drawing unit to identify a movement destination pixel for each of the first pixels or each of pixels belonging to the character string represented by a predetermined font, according to the calculated movement amount, and to replace a color of the movement destination pixel with a predetermined color.

Thus, even when the character string, which is inserted as a caption, protrude out of the display area along with the expansion of the video image, for example, it becomes possible to display the character string within the display area. Incidentally, because only the pixels included in the character string are replaced, the influence to the video image to be originally displayed is minimized.

The caption movement processing apparatus may further include: a caption processing unit to replace a color of a second pixel whose distance to the movement destination pixel is equal to or less than a predetermined distance among pixels other than the movement destination pixels with a color different from the color of the movement destination pixel. Thus, each character included in the character string is fringed with a color different from the color of the character. Therefore, it becomes easy to see the character sting.

The caption movement processing apparatus may further includes: a font storage unit to store, for each character code, a character image of a character, which is represented by a predetermined font; and a caption generation unit to obtain a character code of each character included in the character string by carrying out a character recognition processing for the first portion, to extract a character image corresponding to the obtained character code for each character included in the character string from the font storage unit, and to replace data of the character included in the character string with the extracted character image. Thus, even when a blur of the character occurs by the expansion of the video image, for example, it becomes possible to display the character string with characters that are easy to see.

Moreover, the caption movement calculation unit may include: a unit to calculate a difference between a second movement amount relating to a frame image immediately before the specific frame image and the calculated movement amount, and to determine whether or not the calculated difference is less than a predetermined value; and a unit to replace the calculated movement amount with the second movement amount when it is determined that the calculated difference is less than the predetermined value. Thus, when the movement amount is less than the predetermined value, the movement amount relating to the frame image immediately before the specific frame image. Therefore, it becomes possible to prevent the display of the character string after the movement from flickering.

Furthermore, the caption movement processing apparatus may further include: a unit to calculate an average color of the first pixels. Then, the caption drawing unit may replace a color of the movement destination pixel with the average color.

The caption processing unit may include: a unit to calculate a difference degree between a color of the second pixel and a color of the movement destination pixel for each second pixel; and a unit to replace the color of the second pixel whose difference degree is less than a predetermined reference with a color different from the color of the movement destination pixel.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A caption movement processing apparatus, comprising:
a caption extraction unit to identify first pixels belonging to a first portion regarded as a character string that is inserted with an overlap on a background in an expanded image generated by expanding a specific frame image included in video image data;
a caption movement calculation unit to determine whether or not any one of the first pixels is out of a display area that is a part of the expanded image and to calculate a movement amount for moving the first portion so as to make all of the first pixels or at least a main portion of the first pixels accommodated in the display area when it is determined that anyone of the first pixels is out of the display area; and
a caption drawing unit to identify a movement destination pixel for each of the first pixels or each of pixels belonging to the character string represented by a predetermined font, according to the calculated movement amount, and to replace a color of the movement destination pixel with a predetermined color.

2. The caption movement processing apparatus as set forth in claim 1, further comprising:
a caption processing unit to replace a color of a second pixel whose distance to the movement destination pixel is equal to or less than a predetermined distance among pixels other than the movement destination pixels with a color different from the color of the movement destination pixel.

3. The caption movement processing apparatus as set forth in claim 1, further comprising:
a font storage unit to store, for each character code, a character image of a character, which is represented by a predetermined font; and
a caption generation unit to obtain a character code of each character included in the character string by carrying out a character recognition processing for the first portion, to extract a character image corresponding to the obtained character code for each character included in the character string from the font storage unit, and to replace data of the character included in the character string with the extracted character image.

4. The caption movement processing apparatus as set forth in claim 1, wherein the caption movement calculation unit comprises:
a unit to calculate a difference between a second movement amount relating to a frame image immediately before the specific frame image and the calculated movement amount, and to determine whether or not the calculated difference is less than a predetermined value; and
a unit to replace the calculated movement amount with the second movement amount when it is determined that the calculated difference is less than the predetermined value.

5. The caption movement processing apparatus as set forth in claim 1, further comprising:
a unit to calculate an average color of the first pixels, and
wherein the caption drawing unit replaces a color of the movement destination pixel with the average color.

6. The caption movement processing apparatus as set forth in claim 2, wherein the caption processing unit comprises:
a unit to calculate a difference degree between a color of the second pixel and a color of the movement destination pixel for each second pixel; and
a unit to replace the color of the second pixel whose difference degree is less than a predetermined reference with a color different from the color of the movement destination pixel.

7. A caption movement processing method, comprising:
identifying, by a computer, first pixels belonging to a first portion regarded as a character string that is inserted with an overlap on a background in an expanded image generated by expanding a specific frame image included in video image data;
determining, by the computer, whether or not any one of the first pixels is out of a display area that is a part of the expanded image;
calculating, by the computer, a movement amount for moving the first portion so as to make all of the first pixels or at least a main portion of the first pixels accommodated in the display area when it is determined that any one of the first pixels is out of the display area;
identifying, by the computer, a movement destination pixel for each of the first pixels or each of pixels belonging to the character string represented by a predetermined font, according to the calculated movement amount; and
replacing, by the computer, a color of the movement destination pixel with a predetermined color.

8. A computer-readable, non-transitory storage medium storing a program for causing a computer to execute a process, the process comprising:
identifying first pixels belonging to a first portion regarded as a character string that is inserted with an overlap on a background in an expanded image generated by expanding a specific frame image included in video image data;
determining whether or not any one of the first pixels is out of a display area that is a part of the expanded image;
calculating a movement amount for moving the first portion so as to make all of the first pixels or at least a main portion of the first pixels accommodated in the display area when it is determined that any one of the first pixels is out of the display area;
identifying a movement destination pixel for each of the first pixels or each of pixels belonging to the character string represented by a predetermined font, according to the calculated movement amount; and
replacing a color of the movement destination pixel with a predetermined color.
